(19) United States
(12) Patent Application Publication
(10) Pub. No.: US 2017/0343216 A1
(43) Pub. Date: Nov. 30, 2017

(54) Fuel Nozzle Assembly with Tube Damping

(71) Applicant: General Electric Company, Schenectady, NY (US)

(72) Inventors: Kevin Weston McMahan, Greer, SC (US); Jeffrey Scott LeBegue, Simpsonville, SC (US); Lucas John Stoia, Taylors, SC (US); Satish Akkur Marigowda, Bangalore (IN)

(21) Appl. No.: 15/166,493

(22) Filed: May 27, 2016

(51) Int. Cl. F23R 3/28; F02C 7/22

(52) U.S. Cl. CPC F23R 3/286; F02C 7/222; F05D 2240/35; F05D 2220/32

(57) ABSTRACT

A fuel nozzle assembly includes a fuel plenum body including a forward plate, an aft plate, an outer band extending between the forward plate and the aft plate and a fuel plenum defined within the fuel plenum body. A plurality of tubes extends through the forward wall, the fuel plenum and the aft wall and each tube defines a premix flow passage through and downstream from the fuel plenum body. Each tube is rigidly connected to the aft plate. A damping plate is disposed downstream from the aft plate. At least one tube of the plurality of tubes extends through a corresponding tube opening defined by the damping plate. The damping plate includes a plurality of spring members fixedly connected to the damping plate. At least one spring member of the plurality of spring members is engaged with an outer wall of the at least one tube.

### FIELD OF THE TECHNOLOGY

The present invention generally involves a bundled tube type fuel nozzle assembly for a gas turbine combustor. More specifically, the invention relates to a bundled tube type fuel nozzle assembly with tube vibration damping.

### BACKGROUND

Particular combustion systems for gas turbine engines utilize combustors having bundled tube type fuel nozzles for premixing a gaseous fuel with a compressed air upstream from a combustion zone. A bundled tube type fuel nozzle assembly generally includes multiple tubes that extend through a fuel plenum body which is at least partially defined by a forward plate, an aft plate and an outer sleeve. Compressed air flows into an inlet portion of each tube. Fuel from the fuel plenum is injected into each tube where it premixes with the compressed air before it is routed into the combustion zone.

A portion of each tube may be rigidly connected to the aft plate while a downstream end or tip portion is left unsupported, thereby creating multiple cantilevered tubes. The downstream end or tip portion of each tube extends through a corresponding tube opening defined in a cap plate which is axially spaced from the aft plate of the fuel plenum body and positioned proximate to the combustion chamber. A circumferentially continuous radial gap is defined between an outer surface of each tube at its tip portion and the corresponding tube opening in the cap plate to allow for a cooling fluid such as compressed air to flow around the tube towards the combustion chamber, thereby cooling the tip portion. During operation, the tip portion of each tube may vibrate within the gap potentially resulting in undesirable contact and/or wear between the individual tubes and the cap plate.

### BRIEF DESCRIPTION OF THE TECHNOLOGY

Aspects and advantages are set forth below in the following description, or may be obvious from the description, or may be learned through practice.

One embodiment of the present disclosure is a fuel nozzle assembly. The fuel nozzle assembly includes a fuel plenum body including a forward plate, an aft plate, an outer band extending between the forward plate and the aft plate and a fuel plenum defined within the fuel plenum body. The fuel nozzle assembly further includes a plurality of tubes. Each tube extends through the forward wall, the fuel plenum and the aft wall and defines a respective premix flow passage through and downstream from the fuel plenum body. Each tube is rigidly connected to the aft plate. A damping plate is disposed downstream from the aft plate and at least one tube of the plurality of tubes extends through a corresponding tube opening defined by the damping plate. The damping plate includes a plurality of spring members fixedly connected to the damping plate. At least one spring member of the plurality of spring members is engaged with an outer wall of the at least one tube of the plurality of tubes.

Another embodiment of the present disclosure is a combustor. The combustor includes an end cover coupled to an outer casing and a fuel nozzle assembly disposed within the outer casing and coupled to the end cover via one or more fluid conduits. The fuel nozzle assembly includes a fuel plenum body including a forward plate, an aft plate, an outer band extending between the forward plate and the aft plate and a fuel plenum defined within the fuel plenum body. The fuel nozzle assembly further includes a plurality of tubes. Each tube extends through the forward wall, the fuel plenum and the aft wall and defines a respective premix flow passage through and downstream from the fuel plenum body. Each tube is rigidly connected to the aft plate. A damping plate is disposed downstream from the aft plate and at least one tube of the plurality of tubes extends through a corresponding tube opening defined by the damping plate. The damping plate includes a plurality of spring members fixedly connected to the damping plate. At least one spring member of the plurality of spring members exerts a radial force against an outer wall of a respective tube of the plurality of tubes.

Those of ordinary skill in the art will better appreciate the features and aspects of such embodiments, and others, upon review of the specification.

### BRIEF DESCRIPTION OF THE DRAWINGS

A full and enabling disclosure of the of various embodiments, including the best mode thereof to one skilled in the art, is set forth more particularly in the remainder of the specification, including reference to the accompanying figures, in which:

FIG. 1 is a functional block diagram of an exemplary gas turbine that may incorporate various embodiments of the present disclosure;

FIG. 2 is a simplified cross-section side view of an exemplary combustor as may incorporate various embodiments of the present disclosure;

FIG. 3 is a cross sectioned side view of a portion of an exemplary bundled tube type fuel nozzle assembly as shown in FIG. 2, according to at least one embodiment of the present disclosure;

FIG. 4 is a perspective view of an exemplary embodiment of a damping plate according to at least one embodiment of the present disclosure; and

FIG. 5 is a cross sectioned side view of a portion of an exemplary bundled tube type fuel nozzle assembly as shown in FIG. 3, according to at least one embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel and/or coaxially aligned to an axial centerline of a particular component.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents. Although exemplary embodiments of the present disclosure will be described generally in the context of a fuel nozzle assembly for a land based power generating gas turbine combustor for purposes of illustration, one of ordinary skill in the art will readily appreciate that embodiments of the present disclosure may be applied to any style or type of combustor for a turbomachine and are not limited to combustors or combustion systems for land based power generating gas turbines unless specifically recited in the claims.

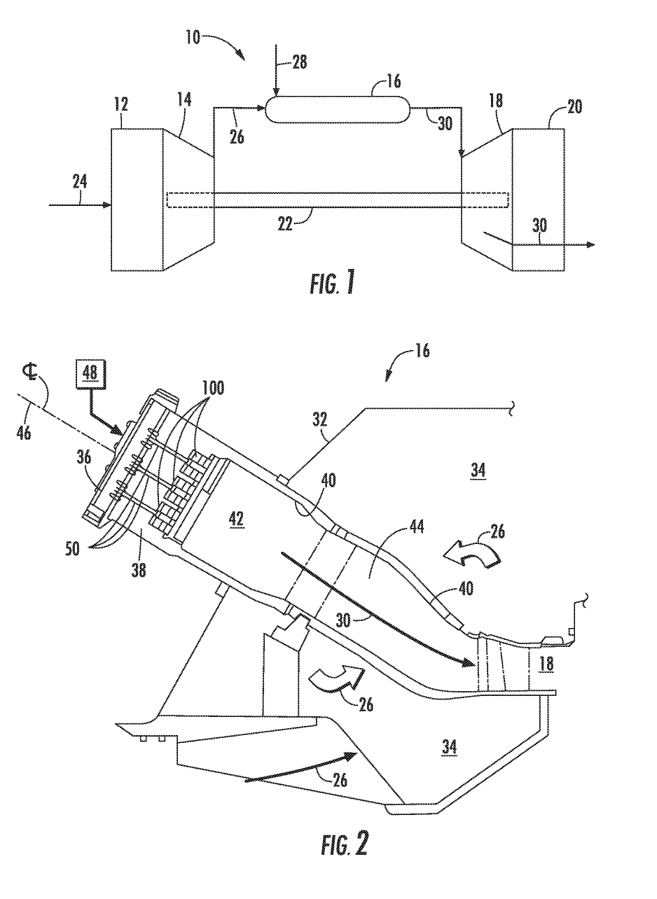

Referring now to the drawings, FIG. 1 illustrates a schematic diagram of an exemplary gas turbine 10. The gas turbine 10 generally includes an inlet section 12, a compressor 14 disposed downstream of the inlet section 12, at least one combustor 16 disposed downstream of the compressor 14, a turbine 18 disposed downstream of the combustor 16 and an exhaust section 20 disposed downstream of the turbine 18. Additionally, the gas turbine 10 may include one or more shafts 22 that couple the compressor 14 to the turbine 18.

During operation, air 24 flows through the inlet section 12 and into the compressor 14 where the air 24 is progressively compressed, thus providing compressed air 26 to the combustor 16. At least a portion of the compressed air 26 is mixed with a fuel 28 within the combustor 16 and burned to produce combustion gases 30. The combustion gases 30 flow from the combustor 16 into the turbine 18, wherein energy (kinetic and/or thermal) is transferred from the combustion gases 30 to rotor blades (not shown), thus causing shaft 22 to rotate. The mechanical rotational energy may then be used for various purposes such as to power the compressor 14 and/or to generate electricity. The combustion gases 30 exiting the turbine 18 may then be exhausted from the gas turbine 10 via the exhaust section 20.

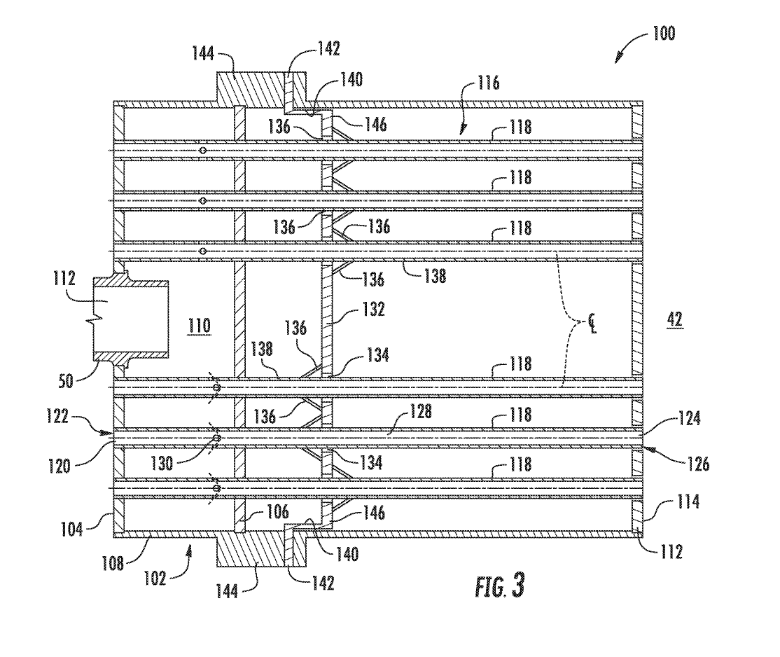

As shown in FIG. 2, the combustor 16 may be at least partially surrounded an outer casing 32 such as a compressor discharge casing. The outer casing 32 may at least partially define a high pressure plenum 34 that at least partially surrounds various components of the combustor 16. The high pressure plenum 34 may be in fluid communication with the compressor 14 (FIG. 1) so as to receive the compressed air 26 therefrom. An end cover 36 may be coupled to the outer casing 32. In particular embodiments, the outer casing 32 and the end cover 36 may at least partially define a head end volume or portion 38 of the combustor 16.

In particular embodiments, the head end portion 38 is in fluid communication with the high pressure plenum 34 and/or the compressor 14. One or more liners or ducts 40 may at least partially define a combustion chamber or zone 42 for combusting the fuel-air mixture and/or may at least partially define a hot gas path through the combustor as indicated by arrow 44, for directing the combustion gases 30 towards an inlet to the turbine 18.

In various embodiments, the combustor 16 includes at least one bundled tube type fuel nozzle assembly 100. As shown in FIG. 2, the fuel nozzle assembly 100 is disposed within the outer casing 32 downstream from and/or axially spaced from the end cover 36 with respect to axial centerline 46 of the combustor 16 and upstream from the combustion chamber 42. In particular embodiments, the fuel nozzle assembly 100 is in fluid communication with a gas fuel supply 48 via one or more fluid conduits 50. In particular embodiments, the fluid conduit(s) 50 may be fluidly coupled and/or connected at one end to the end cover 36.

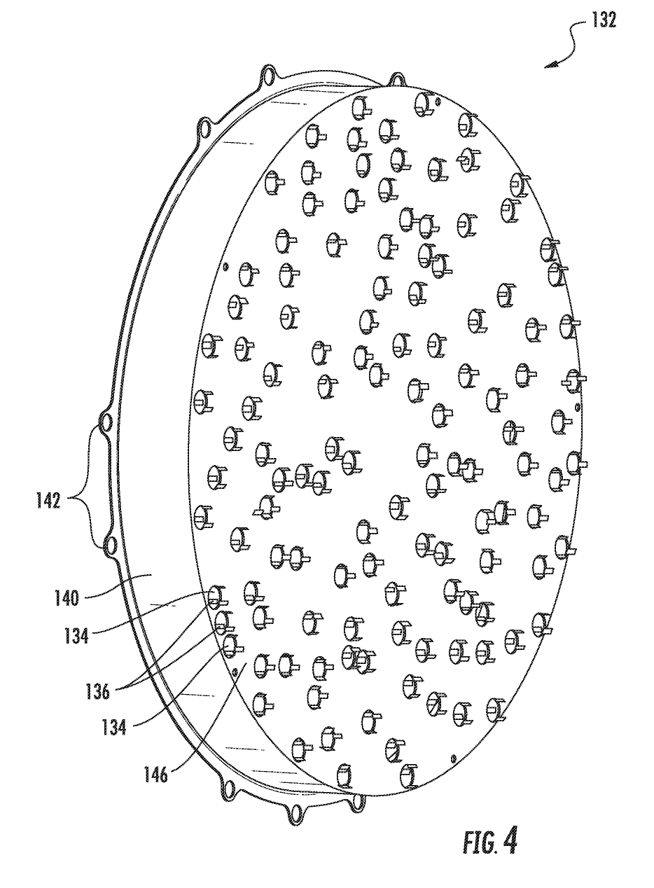

FIG. 3 provides a cross sectioned side view of a portion of an exemplary fuel nozzle assembly 100 as shown in FIG. 2, according to at least one embodiment of the present disclosure. Various embodiments of the combustor 16 may include different arrangements of the fuel nozzle assembly 100 and is not limited to any particular arrangement unless otherwise specified in the claims. For example, in particular configurations as illustrated in FIG. 3, the fuel nozzle assembly 100 includes multiple wedge shaped fuel nozzle segments annularly arranged about centerline 46. In particular embodiments, the fuel nozzle assembly 100 may form an annulus or fuel nozzle passage about a center fuel nozzle 50.

In at least one embodiment, as shown in FIG. 3, the fuel nozzle assembly 100 and/or each fuel nozzle segment includes a fuel plenum body 102 having a forward or upstream plate 104, an aft plate 106 axially spaced from the forward plate 104 and an outer band or shroud 108 that extends axially between the forward plate 104 and the aft plate 106. A fuel plenum 110 is defined within the fuel plenum body 102. In particular embodiments, the forward plate 104, the aft plate 106 and the outer band 108 may at least partially define the fuel plenum 110. In particular embodiments, fluid conduit 50 may extend through the forward plate 104 to provide fuel to the fuel plenum 110. In various embodiments, the fuel nozzle assembly 100 includes a cap plate 112 axially spaced from the aft plate 106. A hot side 114 of the cap plate 112 is generally disposed adjacent or proximate to the combustion chamber 42.

As shown in FIG. 3, the fuel nozzle assembly 100 includes a tube bundle 116 comprising a plurality of tubes 118. Each tube 118 extends through the forward plate 104, the fuel plenum 110, the aft plate 106 and the cap plate 112. The tubes 118 are fixedly connected to and/or form a seal against the aft plate 106. For example, the tubes 118 may be welded, brazed or otherwise connected to the aft plate 106. Each tube 118 includes an inlet 120 defined at an upstream end 122 of each respective tube 118 and an outlet 124 defined at a downstream end 126 of each respective tube 118. Each tube 118 defines a respective premix flow passage 128 through the fuel nozzle assembly 100. In particular embodiments, one or more tubes 118 of the plurality of tubes 118 is in fluid communication with the fuel plenum 110 via one or more fuel ports 130 defined within the respective tube(s) 118.

During operation of known fuel nozzle assemblies, the cantilevered tubes 118, particularly the downstream end portion 126 of each tube 118 vibrates due, for example, to combustion dynamics and/or due to mechanical vibrations transferred to the tubes 118 via the gas turbine 10. In certain instances, the vibrations may cause the tubes 118 to move radially with respect to a centerline of each respective tube 118 which may result in contact between the tubes 118 and the cap plate 112. This contact may result in undesirable wear on the cap plate 112 and/or on the tubes 118.

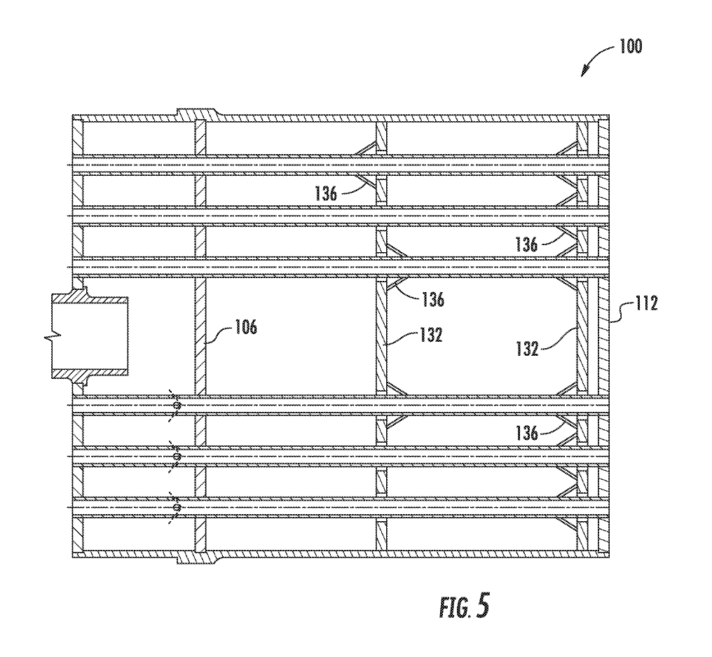

In various embodiments of the present disclosure, as shown in FIG. 3, the fuel nozzle assembly 100 includes a damping plate 132 disposed downstream from the aft plate 106. FIG. 4 provides a perspective view of an exemplary embodiment of the damping plate 132 according to at least one embodiment of the present disclosure. In particular embodiments, the damping plate 132 may be circular. However, the shape of the damping plate 132 is not limited to a circular shape unless otherwise recited in the claims. In particular embodiments, the damping plate 132 is positioned between the aft plate 106 and the cap plate 112.

As shown in FIGS. 3 and 4, the damping plate includes and/or defines a plurality of tube openings 134. Each tube opening 134 is generally coaxially aligned with a respective centerline of a respective tube 118 of the plurality of tubes 118. When installed into the fuel nozzle assembly 100, at least one tube 118 of the plurality of tubes 118 extends through a corresponding tube opening 134.

The damping plate 132 includes a plurality of spring or damping members 136 fixedly connected to an outer surface of the damping plate 132. Each spring member 136 is positioned proximate to a respective tube opening 134. In particular embodiments, as shown in FIG. 4, at least one tube opening 134 may be at least partially circumferentially surrounded by one or more spring members 136. In at least one embodiment, each tube opening 134 is at least partially surrounded by at least one spring member 136 of the plurality of spring members 136. In at least one embodiment, at least one tube opening 134 is surrounded by two or more circumferentially spaced spring members 136.

As shown in FIG. 3, one or more of the spring members 136 may be engaged or press against with an outer wall 138 of a respective tube 118 of the plurality of tubes 118. The spring members 136 may be formed or bent so as to radially load against the respective tube(s) 120, thereby reducing radial movement of the tube resulting from combustion dynamics and/or the rotation of the rotor shaft 22. The spring members 136 may be formed from an alloy or other suitable material. In particular embodiments, as illustrated in FIG. 3, at least one spring member 136 of the plurality of spring members 136 extends axially from the damping plate 132 towards the cap plate 112. In particular embodiments, at least one spring member 136 of the plurality of spring members 136 extends axially from the damping plate 132 towards the aft plate 106.

FIG. 4 provides a cross sectioned side view of a portion of an exemplary fuel nozzle assembly 100 as shown in FIG. 3, according to at least one embodiment of the present disclosure. In particular embodiments, each of the spring members 136 may have the same spring constant or stiffness. In one embodiment, the plurality of spring members 136 may include a first subset of spring members and a second subset of spring members where the first subset of the spring members has a first spring constant or stiffness and the second subset of spring members has a second spring constant stiffness that is the same or different from the first subset of spring members 136.

In particular embodiments, as shown in FIGS. 3 and 4, the damping plate 132 includes an outer band 140 that extends circumferentially about a periphery of the damping plate 132. In particular embodiments, the damping plate 132 includes a plurality of circumferentially spaced mounting flanges 142 extending radially outwardly from the outer band 140. In particular embodiments, as shown in FIG. 3, the mounting flanges 142 may be connected via a mechanical fastener of otherwise fixedly connected to a casing or sleeve 144 of the combustor 16. The plurality of mounting flanges 142 may be axially offset from a top surface 146 of the damping plate 132.

FIG. 5 provides a cross sectioned side view of a portion of the exemplary fuel nozzle assembly 100 as shown in FIG. 3, according to at least one embodiment of the present disclosure. The axial positioning of the damping plate 132 with respect to the aft plate 106 and/or the cap plate 112 and/or the axial orientation of the spring members 136 may be specified based at least in part on particular frequencies to be addressed within the combustor 16. For example, in particular embodiments, as shown in FIG. 3, the damping plate 132 may be positioned proximate to or closer to the aft plate 106. In particular embodiments, the damping plate 132 may be positioned proximate to or closer to the cap plate 112. In one embodiment, the damping plate 132 may be immediately adjacent to the cap plate 112 with at least some of the spring members 136 extending towards the aft plate 106. In particular embodiments, as shown in FIG. 5, the fuel nozzle assembly 100 may include two or more damping plates 134.

The various embodiments illustrated and described herein provide various technical benefits over exiting fuel nozzle assemblies. For example, the radial load exerted on the individual tubes 118 by the spring members 136 reduces tube wear at the joint formed between each respective tube 118 and the aft plate 106, thereby reducing the potential for fuel leakage from the fuel plenum 110 and/or prevents the tubes 118 from vibrating against the cap plate 112 during operation of the combustor 16, thus improving tube life. In addition, the relative positioning of the damping plate 132 with respect to the aft plate 106 and/or the cap plate 112 may be modified depending on combustion dynamics or mechanical vibrations of a particular gas turbine. The orientation and/or stiffness of the spring members 136 may be modified and/or specified to mitigate vibrations of the tubes as a result of combustion dynamics or mechanical vibrations of a particular gas turbine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fuel nozzle assembly, comprising:
a fuel plenum body including a forward plate, an aft plate, an outer band that extends between the forward plate and the aft plate and a fuel plenum defined within the fuel plenum body;
a plurality of tubes, each tube extending through the forward wall, the fuel plenum and the aft wall, wherein each tube is rigidly connected to the aft plate; and
a damping plate disposed downstream from the aft plate, at least one tube of the plurality of tubes extending through a corresponding tube opening defined by the damping plate, wherein the damping plate includes a plurality of spring members fixedly connected to the damping plate, wherein at least one spring member of the plurality of spring members is engaged with an outer wall of the at least one tube of the plurality of tubes.

2. The fuel nozzle assembly as in claim 1, wherein the damping plate includes an outer band that extends circumferentially about a periphery of the damping plate and a plurality of circumferentially spaced mounting flanges extending radially outwardly from the outer band.

3. The fuel nozzle assembly as in claim 1, wherein the plurality of mounting flanges is axially offset from a top surface of the damping plate.

4. The fuel nozzle assembly as in claim 1, wherein the damping plate is circular.

5. The fuel nozzle assembly as in claim 1, further comprising a cap plate axially spaced from the aft plate, wherein a downstream end of each tube of the plurality of tubes extends through the cap plate and wherein the damping plate is positioned between the aft plate and the cap plate.

6. The fuel nozzle assembly as in claim 1, further comprising a cap plate axially spaced from the aft plate, wherein a downstream end of each tube of the plurality of tubes extends through the cap plate and wherein at least one spring member of the plurality of spring members extends axially from the damping plate towards the cap plate.

7. The fuel nozzle assembly as in claim 1, further comprising a cap plate axially spaced from the aft plate, wherein a downstream end of each tube of the plurality of tubes extends through the cap plate and wherein at least one spring member of the plurality of spring members extends axially from the damping plate towards the aft plate.

8. The fuel nozzle assembly as in claim 1, wherein each tube opening is at least partially surround by at least one spring member of the plurality of spring members.

9. The fuel nozzle assembly as in claim 1, wherein each tube opening includes two or more circumferentially spaced spring members.

10. The fuel nozzle assembly as in claim 1, wherein the plurality of spring members includes a first subset of spring members and a second subset of spring members, wherein the first subset of the spring members has a first stiffness and the second subset of spring members has a second stiffness.

11. A combustor, comprising:
an end cover coupled to an outer casing;
a fuel nozzle assembly disposed within the outer casing and coupled to the end cover via one or more fluid conduits, wherein the fuel nozzle assembly comprises:
a fuel plenum body including a forward plate, an aft plate, an outer band that extends between the forward plate and the aft plate and a fuel plenum defined within the fuel plenum body;
a plurality of tubes, wherein each tube defines a premix flow passage through and downstream from the fuel plenum body, wherein each tube is rigidly connected to the aft plate; and
a damping plate disposed downstream from the aft plate, at least one tube of the plurality of tubes extending through a corresponding tube opening defined by the damping plate, wherein the damping plate includes a plurality of spring members fixedly connected to the damping plate, wherein at least one spring member of the plurality of spring members is engaged with an outer wall of the at least one tube of the plurality of tubes.

12. The combustor as in claim 11, wherein the damping plate includes an outer band that extends circumferentially about a periphery of the damping plate and a plurality of circumferentially spaced mounting flanges extending radially outwardly from the outer band.

13. The combustor as in claim 11, wherein the plurality of mounting flanges is axially offset from a top surface of the damping plate.

14. The combustor as in claim 11, wherein the damping plate is circular.

15. The combustor as in claim 11, wherein the fuel nozzle assembly further comprises a cap plate axially spaced from the aft plate, wherein a downstream end of each tube of the plurality of tubes extends through the cap plate and wherein the damping plate is positioned between the aft plate and the cap plate.

16. The combustor as in claim 11, wherein the fuel nozzle assembly further comprises a cap plate axially spaced from the aft plate, wherein a downstream end of each tube of the plurality of tubes extends through the cap plate and wherein at least one spring member of the plurality of spring members extends axially from the damping plate towards the cap plate.

17. The combustor as in claim 11, wherein the fuel nozzle assembly further comprises a cap plate axially spaced from the aft plate, wherein a downstream end of each tube of the plurality of tubes extends through the cap plate and wherein at least one spring member of the plurality of spring members extends axially from the damping plate towards the aft plate.

18. The combustor as in claim 11, wherein each tube opening is at least partially surround by at least one spring member of the plurality of spring members.

19. The combustor as in claim 11, wherein each tube opening includes two or more circumferentially spaced spring members of the plurality of spring members.

20. The combustor as in claim 11, wherein the plurality of spring members includes a first subset of spring members and a second subset of spring members, wherein the first subset of the spring members has a first stiffness and the second subset of spring members has a second stiffness.
